(19) United States
(12) Patent Application Publication
(10) Pub. No.: US 2012/0101905 A1
(43) Pub. Date: Apr. 26, 2012

(54) Method and Apparatus for Generating a Multimedia Advertisement

(76) Inventors: Pravin Yeluri, Maharahstra (IN); Suman Sahu, Maharashtra (IN); Abhijit Chakravarty, Maharashtra (IN)

(21) Appl. No.: 13/266,855

(22) PCT Filed: Apr. 28, 2010
(86) PCT No.: PCT/IN2010/000269

§ 371 Date: Oct. 28, 2011

(30) Foreign Application Priority Data
Apr. 28, 2009 (IN) 1121/MUM/2009

(51) Int. Cl. G06Q 30/02

(52) U.S. Cl. 705/14.72

(57) ABSTRACT

A method and system for generating multimedia advertisement is disclosed. In an embodiment, a method for generating multimedia advertisement is disclosed. The method comprising accessing user selected files, accessing an information file, processing user selected image files or video files using the information file, processing user selected audio files using the information file, and generating a multimedia advertisement file.

### CROSS REFERENCE TO RELATED APPLICATIONS

This application claims benefit of Indian provisional patent application serial number 1121/MUM/2009, filed on Apr. 28, 2009, which is herein incorporated by reference. This application also claims benefit to the PCT application number PCT/IN2010/000269 and filing date is Apr. 28, 2010, which claims the benefit of the identified Indian provisional patent application.

### FIELD OF THE INVENTION

Embodiments of the present invention generally relate to multimedia processing techniques and more particularly to a method and apparatus for generating a multimedia advertisement.

### BACKGROUND OF THE INVENTION

In today's highly competitive market, users such as, service or product providers, small to medium sized organizations, freelancing groups or an individual and/or the like, need to reach out new and/or potential customers. As such, the users utilize each and every possible technique to entice the potential customers about their products or services. For example, the users, typically, explore various types of advertisement channels to publicize their products or services.

Generally, various types of advertisement channels, such as, paper publications (e.g., newspapers, magazines), cinematographic works, broadcasting services (e.g., radio services, television channels, video on demand services, online video streaming, internet television) and/or the like, are utilized by the users to gain access to the potential customers. As such, among other advertisements, a multimedia advertisement has become quite popular among the users.

Conventionally, various professional advertising agencies are involved in generating the multimedia advertisement for the users. Further, the advertising agencies charge high cost and thereby, put financial constraints on the users. Moreover, the users may successively need to edit the multimedia advertisement in accordance with various geographical regions. Furthermore, generation of the multimedia advertisement is not a viable and user friendly option.

Therefore, there is a need in the art for a method and apparatus for generating a multimedia advertisement.

### BRIEF SUMMARY OF THE INVENTION

Various embodiments of the invention comprise a method and system for generating a multimedia advertisement. In one embodiment, a method for generating a multimedia advertisement is disclosed. The method includes accessing user selected files, accessing an information file, processing user selected image files or video files using the information file, processing user selected audio files using the information file, and generating a multimedia advertisement file.

In another embodiment, a system for generating a multimedia advertisement is disclosed. The system includes at least one server, and at least one computing node coupled to the at least one server through a network. The computing node comprising an agent for accessing user selected files, accessing an information file, processing user selected image files or video files using the information file, processing user selected audio files using the information file, and generating the multimedia advertisement file.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of an example system for generating a multimedia advertisement in accordance with one or more embodiments of the invention;

FIG. 2 illustrates an example flow diagram in accordance with one or more embodiments of the invention; and

FIG. 3A-C illustrate an example graphical user interfaces (GUIs) in accordance with one or more embodiments of the invention.

### DETAILED DESCRIPTION OF THE INVENTION

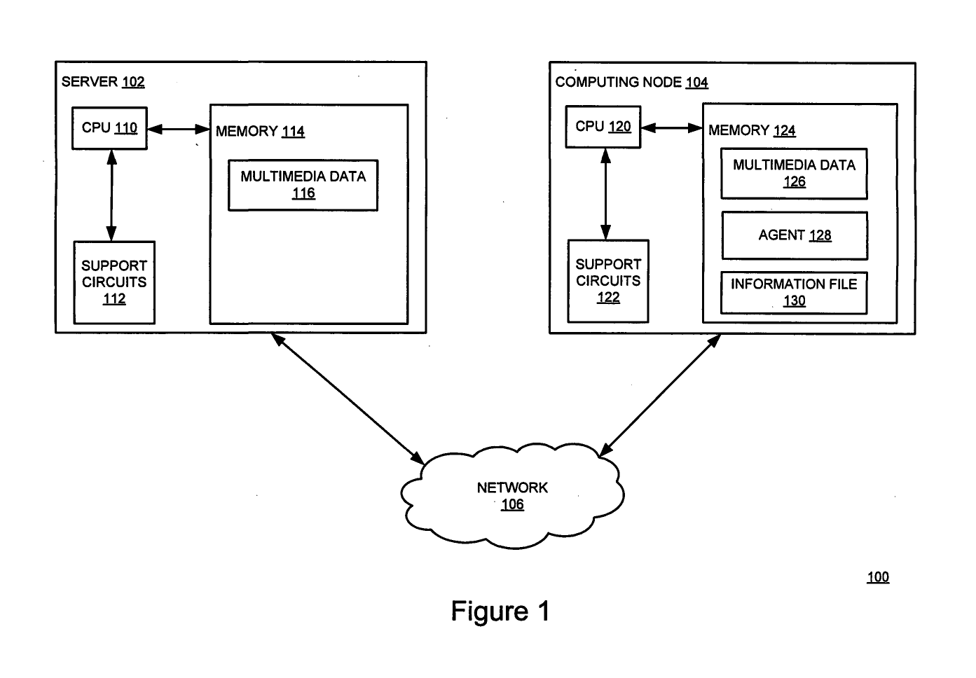

FIG. 1 is a block diagram of an example system 100 for generating a multimedia advertisement according to various embodiments of the invention. The system 100 comprises a server 102 and a computing node 104, coupled to each other through a network 106. It is appreciated that the system 100 comprises one or more servers 102 and/or one or more computing nodes 104, coupled to the network 106.

The network 106 comprises a communication system that connects computers by wire, cable, fiber optic and/or wireless link facilitated by various types of well-known network elements, such as hubs, switches, routers, and the like. The network 106 may employ various well-known protocols to communicate information amongst the network resources. For example, the network 106 may be a part of the internet or intranet using various communications infrastructure such as Ethernet, WiFi1 WiMax, General Packet Radio Service (GPRS), and the like. Furthermore, the network 106 may form a portion of a Storage Network Area (SAN) using various communications infrastructure such as Ethernet, Fibre Channel, InfiniBand, iSCSI and the like.

The server 102 is a type of computing device (e.g., a laptop, a desktop, a Personal Digital Assistant (PDA) and/or the like), such as those generally known in the art. The server 102 includes a Central Processing Unit (CPU) 110, various support circuits 112 and a memory 114. The CPU 110 may comprise one or more commercially available microprocessors or microcontrollers that facilitate data processing and storage. The various support circuits 112 facilitate the operation of the CPU 110 and include one or more clock circuits, power supplies, cache, input/output circuits, and the like. The memory 114 comprises at least one of Read Only Memory (ROM), Random Access Memory (RAM), disk drive storage, optical storage, removable storage and/or the like. The memory 114 includes among other data resources, a multimedia data 116.

The multimedia data 116 includes one or more multimedia advertisement files, a plurality of library files and/or like. The library files can include various image files, video files, audio files, text files and/or the like. The image files include files having image file format such as, GIF, JPEG, BMP and/or other image file formats generally known in the art. Additionally, the audio files include files having audio file format, such as, .WAV, .AU, .MP3, and/or other audio file formats generally known in the art. Furthermore, the video files include files having video file format such as, .MP4, .MPEG, .WMV and/or other video file formats generally known in the art.

The computing node 104 is a type of computing device (e.g., a laptop, a desktop, a Personal Digital Assistant (PDA) and/or the like), such as those generally known in the art. The computing node 104 includes various computing resources, such as application resources, replication resources, database resources, network resources, storage resources and/or the like. Furthermore, the computing node 104 includes a Central Processing Unit (CPU) 120, various support circuits 122 and a memory 124.

The CPU 120 may comprise one or more commercially available microprocessors or microcontrollers that facilitate data processing and storage. The various support circuits 122 facilitate the operation of the CPU 120 and include one or more clock circuits, power supplies, cache, input/output circuits, and the like. The memory 124 comprises at least one of Read Only Memory (ROM), Random Access Memory (RAM), disk drive storage, optical storage, removable storage and/or the like. The memory 124 includes a multimedia data 126, an agent 128 and an information file 130.

The multimedia data 126 includes one or more multimedia advertisement files, a plurality of library files and/or like. The library files can include various image files, video files, audio files, text files and/or the like. The image files include files having image file format such as, .GIF, JPEG, .BMP and/or other image file formats generally known in the art. Additionally, the audio files include files having audio file format, such as, .WAV, .AU, .MP3, and/or other audio file formats generally known in the art. Furthermore, the video files include files having video file format such as, .MP4, .MPEG, .WMV and/or other video file formats generally known in the art.

According to one or more embodiments of the invention, the user accesses the multimedia data 116 and/or the multimedia data 126 for generating a new multimedia advertisement file. Generally, the agent 128 provides an access to the user to the plurality of library files that includes plurality of image files, audio files, video files and/or the like. Additionally, the agent 128 includes various software packages for selecting and/or processing the image files, the audio files, the video files and/or the like.

In one embodiment, the user selects the one or more files from the plurality of library files. Additionally and/or alternatively, the user may process the selected one or more files using the agent 128. For example, the user may edit the selected audio files for providing audio effects within any existing multimedia advertisement files using the agent 128. Furthermore, the user may edit the selected image files through the agent 128. Subsequently, the agent 128 stores the processed information on user selected files in the information file 130.

Generally, the information file 130 includes information, such as storage location of the user selected files in the memory 114 and/or the memory 124, processing information (e.g., editing information) on the user selected files, timing information (e.g., a playing time of the files) associated with the user selected files. In one embodiment, the information file 130 is in Extensible Mark up Language (XML) format. Additionally, the agent 128 analyzes the information file 130 and thereby uses the user selected files and the information file 130 for generating the new multimedia advertisement files. Subsequently, the user stores the multimedia advertisement files on the computing node 104. Alternatively, the user stores the multimedia advertisement files on the server 102.

According to various embodiments of the invention, the user generates the multimedia advertisement files in accordance with various geographical regions. As such, the multimedia data 116 and/or the multimedia data 126 may include multilingual data. The multilingual data is in accordance with the various geographical regions. The agent 128 enables the user to access the multilingual data. Accordingly, the user selects one more multilingual data in combination with the selection of one or more image files, audio files, and/or video files and thereby the agent 128 generates a new multimedia advertisement file in accordance with the various geographical regions. In one example, the agent 128 is configured to generate the multimedia advertisement file in a geographic language of the geographical regions. For example, the agent utilizes a local Indian language in order to generate the multimedia advertisement file. Additionally, the agent 128 automatically insert a disclaimer within the multimedia advertisement file.

According to one or more embodiments of the invention, the system 100 processes the user generated multimedia advertisement files. As an example and not as a limitation, the server 102 forwards the multimedia advertisement files to various advertisement channels, such as, television channels, print, internet, cinema, radio channels, video on demand service channels, online video streaming channels, internet television channels, cinema, outdoor advertisement channels, and/or other electronic multimedia channels generally known in the art.

In one embodiment, the system 100 provides an access to the user for selecting one or more advertisement spots within advertisement channels, for example using an advertising planner tool. In one embodiment, the advertisement planner tool is the advertisement planner disclosed in the provisional patent application titled “Method and apparatus for planning a schedule of multimedia advertisements in a broadcasting channel” being co-filed with this application. Using the advertising planner tool or otherwise, the user assigns the multimedia advertisement file to the advertisement spots and thereby enables the user for displaying the multimedia advertisement files on the one or more advertisement channels.

According to various embodiments, the system 100 replaces the existing multimedia advertisement files at the one or more advertisement spots with the assigned multimedia advertisement files using a splicing operation and thereby enables the user to display assigned multimedia advertisement files on the one or more advertisement channels. In one embodiment, the splicing operation is accomplished by the splicer disclosed in the provisional patent application titled “Method and apparatus for splicing a compressed data stream” being co-filed with this application.

Alternatively, the system 100 may replace the existing multimedia advertisement files at the one or more advertisements spots with the assigned multimedia advertisement files in various media channels, in various media channels, such as, television channels, print, internet, cinema, radio channels, video on demand service channels, online video streaming channels, internet television channels, outdoor advertisement channels and/or other electronic multimedia channels generally known in the art.

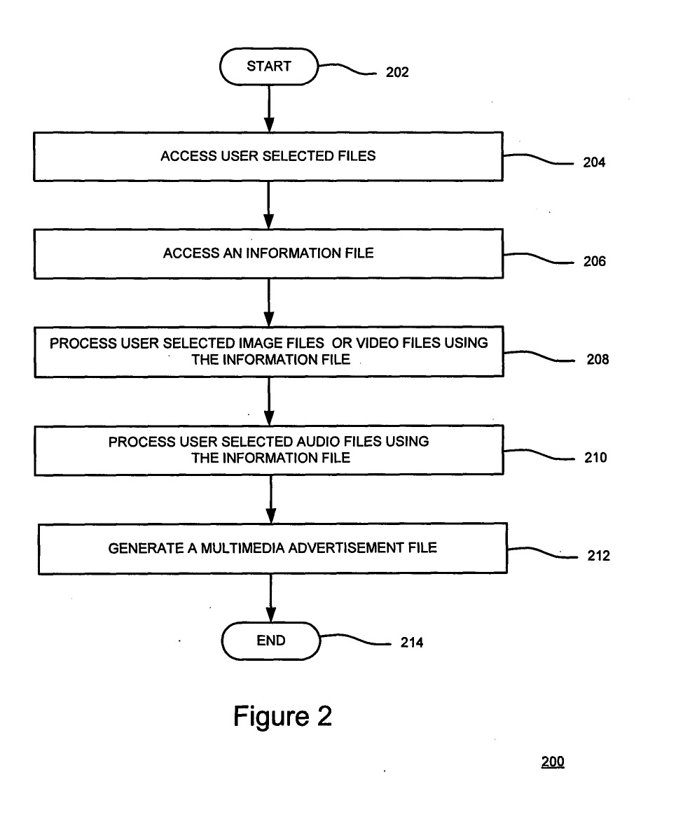

FIG. 2 illustrates an example flow method for generating the multimedia advertisement in accordance with one or more embodiments of the invention. The method 200 starts at step 202 and proceeds to step 204. At step 204, user selected files (e.g., image files, audio files, video files of the multimedia data 116 and/or the multimedia data 126 of the FIG. 1) are accessed.

At step 206, an information file (e.g., the information file 130 of the FIG. 1) is accessed. At step 208, the user selected image files and/or video files are processed using the information file. For example, an agent 128 may process the user selected image files using the information file and image processing software such as, an ImageMagick™ and the like. Additionally, the agent generates a sequence of images using the processed user selected image files and/or video files.

At step 210, the user selected audio files are processed using the information file. For example, the agent may process the user selected audio files using the information file and audio processing software such as, a Flash player, GNASH player and/or the like. Additionally, the agent generates an audio file from the processed user selected audio files.

At step 212, a multimedia advertisement file is generated. In one embodiment, the agent generates the sequence of images and the audio file in accordance with the standards such as, MPEG-2, MPEG 4, Flash and/or the like. Subsequently, the agent processes the generated sequence of images and creates video component of the multimedia advertisement file. Accordingly, the agent processes the generated audio file and creates the audio component of the multimedia advertisement file. Consequently, the agent mixes the video component and audio component and thus generates the multimedia advertisement file. The method 200 proceeds to step 214. At step 214, the method 200 ends.

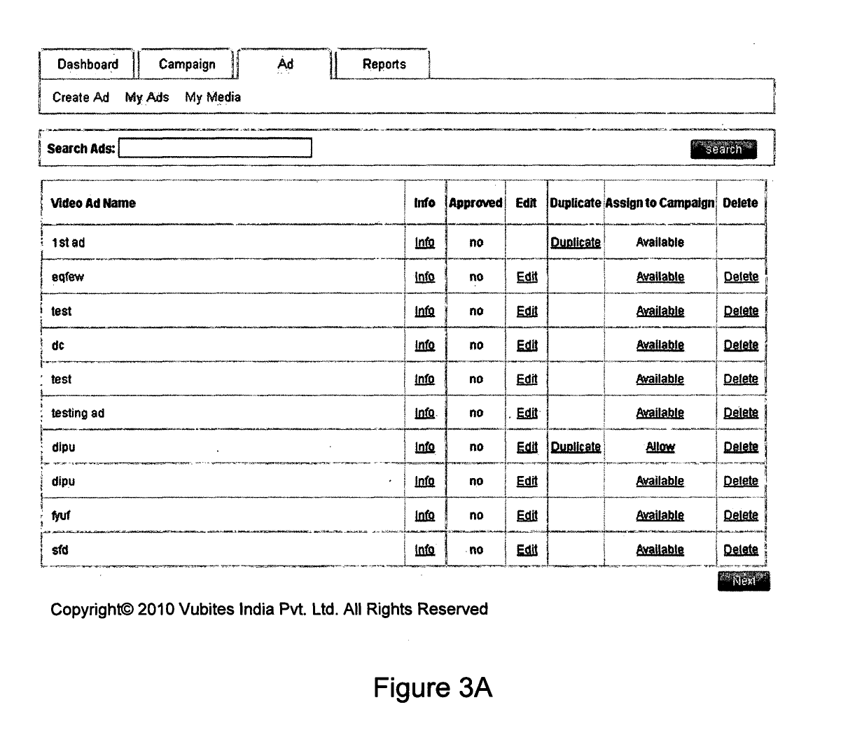

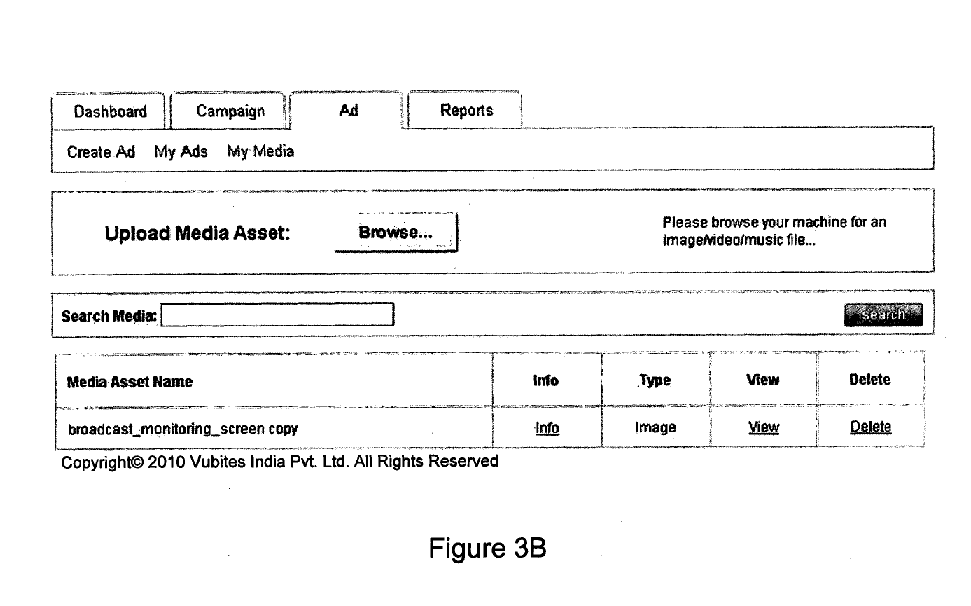

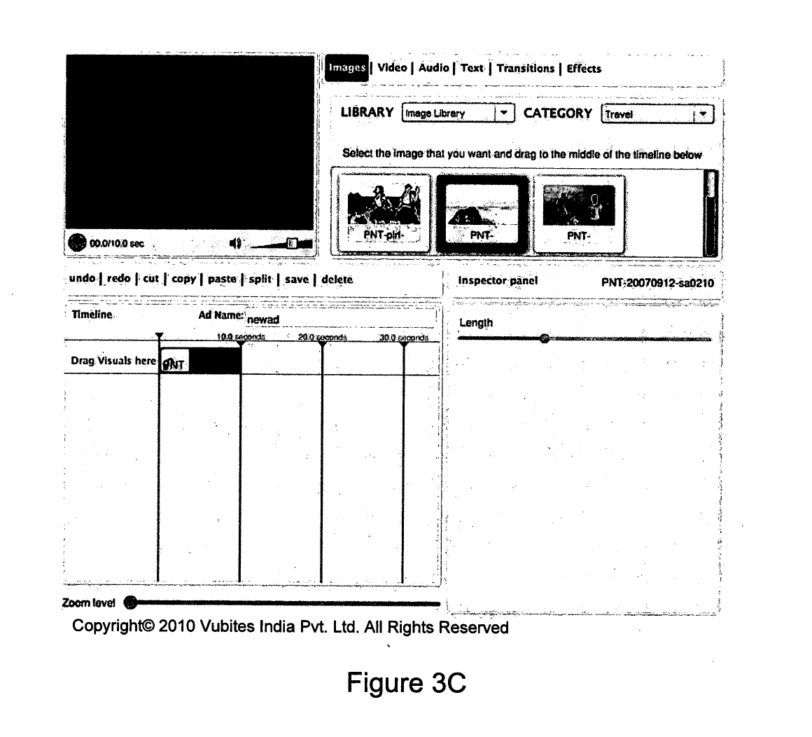

FIG. 3A-C illustrate an example graphical user interfaces (GUIs) in accordance with one or more embodiments of the invention. FIG. 3A illustrates an example graphical user interface for generating the multimedia advertisement file in accordance with one or more embodiments of the invention. FIG. 3B illustrates another example graphical user interface for selecting one or more multimedia files for generating the multimedia advertisement files. FIG. 3C illustrates an example graphical user interface for selecting the multimedia advertisement file.

Further, various embodiments discussed herein enable a method of doing business, wherein advertisements may inserted into an advertisement stream such that the inserted advertisements are shown in relatively smaller geographical area, e.g. an area pertaining to a cable head end. The inserted advertisements may be different than the original broadcasted advertisements. This has various advantages for advertisers, broadcasters and the viewers, and such a method of doing business is disclosed in provisional patent application “Method and system for broadcasting multimedia data” being co-filed with this application. Advertisement generator provides several advantages to such a business method, especially in creating high quality and comparatively inexpensive advertisements for medial channels, such as, television channels, print, internet, cinema, radio channels, video on demand service channels, online video streaming channels, internet television channels, outdoor advertisement channels and/or other electronic multimedia channels generally known in the art.

While the foregoing is directed to embodiments of the present invention, other and further embodiments of the invention may be devised without departing.

What is claimed is:

1. A method for generating a multimedia advertisement comprising: accessing user selected files and an information file; processing user selected image files or video files using the information file; processing user selected audio files using the information file; and generating a multimedia advertisement file.

2. The method of claim 1, wherein the user selected files are selected from a group comprising image files, audio files, and video files.

3. The method of claim 1, wherein accessing the information file comprises accessing storage location information, processing information, and timing information associated with the user selected files.

4. The method of claim 1 further comprising editing the selected image files or video files for generating the multimedia advertisement file.

5. The method of claim 1 further comprising editing the audio image files for providing audio effects within the multimedia advertisement files.

6. The method of claim 1, wherein generating the multimedia advertisement file comprising mixing the processed user selected image files or video files and the processed user selected audio files.

7. The method of claim 1, wherein generating the multimedia advertisement file is done in accordance with geographical regions.

8. A system for generating a multimedia advertisement comprising:
at least one server; and
at least one computing node coupled to the at least one server through a network, the computing node comprising an agent for accessing user selected files and an information file, processing user selected image files or video files using the information file, processing user selected audio files using the information file, and generating the multimedia advertisement file.

9. The system of claim 8, wherein the agent is configured to store the processed information on the user selected files in the information file.

10. The system of claim 8, wherein the agent is configured to edit the audio image files for providing audio effects within the multimedia advertisement files.

11. The system of claim 8, wherein the agent is configured to edit the selected image files or video files for creating the multimedia advertisement file.

12. The system of claim 8, wherein the agent is configured to generate a multimedia advertisement file in accordance with geographical regions.

13. The system of claim 8, wherein the agent is configured to generate the multimedia advertisement file by mixing the processed user selected image files or video files and the processed user selected audio files.

14. The system of claim 8, wherein the multimedia advertisement files are stored on the server and/or the computing node by users.

15. The system of claim 12, wherein the agent is configured to generate the multimedia advertisement file in a geographic language of the geographical regions.

16. The system of claim 8, wherein the agent is configured to automatically insert a disclaimer within the multimedia advertisement file.
